(19) United States
(12) Patent Application Publication
(10) Pub. No.: US 2026/0212707 A1
(43) Pub. Date: Jul. 23, 2026

(54) Signature Verification System and Method Based on Image Analysis

(71) Applicant: ViewSonic International Corporation, New Taipei City (TW)

(72) Inventor: Chin-Te Cheng, New Taipei City (TW)

(73) Assignee: ViewSonic International Corporation, New Taipei City (TW)

(21) Appl. No.: 19/090,410

(22) Filed: Mar. 26, 2025

(30) Foreign Application Priority Data
Jan. 23, 2025 (TW) 114102971

(51) Int. Cl. G06V 40/30; G06V 40/20

(52) U.S. Cl. CPC G06V 40/33; G06V 40/28

(57) ABSTRACT

A signature verification method based on image analysis includes capturing a handwriting data of a signatory performing a signature process by a signature capture device; capturing an image data of the signatory performing the signature process by an image capturing device; obtaining feature information from the image data; comparing the handwriting data and the feature information with authentication reference data to generate a comparison result; and determining authenticity of the signature process based on the comparison result.

### BACKGROUND OF THE INVENTION

### Field of the Invention

The present invention relates to a signature verification system and method based on image analysis, and more particularly, to a signature verification system and method that utilize an image capturing device to capture image data during a signature process and determining the authenticity of signatures accordingly.

### Description of the Prior Art

Traditional signature verification methods primarily rely on static signature comparison. For example, when signing documents, verification personnel visually compares the current signature with pre-stored signature templates. This comparison manner depends on the experience and judgment of the verification personnel, making it prone to subjective errors. Moreover, comparison of static signature cannot reflect dynamic features during the signing process, such as signing speed and stylus pressure, making it susceptible to forgery.

With technological advancement, electronic signature pads have been widely applied. However, the electronic signature pads can only record two-dimensional signature information without verification of signature process, making it difficult to prevent imitation by others. Although the development of biometric recognition technologies (such as fingerprint recognition, facial recognition, iris recognition, etc.) has provided new solutions for identity verification, additional or specialized hardware is required to support the signature verification process and cannot be effectively integrated.

Therefore, providing a more reliable signature verification mechanism without the need for specialized hardware equipment has become an objective of the industry.

### SUMMARY OF THE INVENTION

Therefore, the present invention is to provide a signature verification system and method based on image analysis, to provide a more reliable signature verification mechanism.

An embodiment of the present invention discloses a signature verification method based on image analysis, which comprises capturing a handwriting data of a signatory performing a signature process by a signature capture device; capturing an image data of the signatory performing the signature process by an image capturing device; obtaining feature information from the image data; comparing the handwriting data and the feature information with authentication reference data to generate a comparison result; and determining authenticity of the signature process based on the comparison result.

Another embodiment of the present invention discloses a signature verification system based on image analysis, which comprises a signature capture device, configured to capture handwriting; an image capturing device, configured to capture images; a processing unit, coupled to the signature capture device and the image capturing device; and a storage unit, coupled to the processing unit and storing a program code, wherein the program code instructs the processing unit to execute a signature verification method, and the signature verification method includes using the signature capture device to capture a handwriting data of a signatory performing a signature process; using the image capturing device to capture an image data of the signatory performing the signature process; obtaining feature information from the image data; comparing the handwriting data and the feature information with authentication reference data to generate a comparison result; and determining authenticity of the signature process based on the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a signature verification system according to an embodiment of the present invention.

FIG. 2 is a schematic diagram of a signature verification process according to an embodiment of the present invention.

FIG. 3A, FIG. 3B, FIG. 3C and FIG. 3D are schematic diagrams of signature process images.

### DETAILED DESCRIPTION

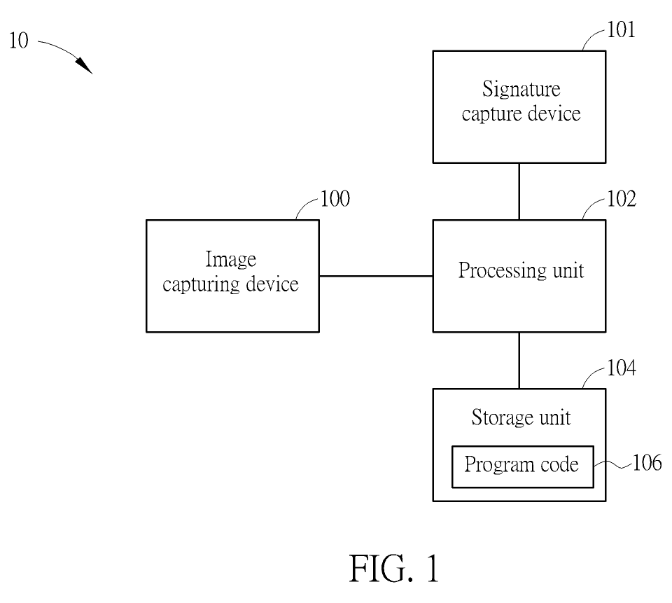

Please refer to FIG. 1, which is a schematic diagram of a signature verification system 10 according to an embodiment of the present invention. The signature verification system 10 verifies the authenticity of a signature based on image analysis, and includes a signature capture device 101, an image capturing device 100, a processing unit 102, and a storage unit 104. The image capturing device 100 can be a camera or any device with image capture functionality, used for capturing images, and the image capturing device 100 is positioned at an appropriate location to clearly capture the hand movements and the signature process of the signatory. The signature capture device 101 can be an electronic signature pad, touch panel, pressure sensing pad, or other device capable of detecting or capturing handwriting. The processing unit 102 is coupled to the image capturing device 100 and the signature capture device 101, configured to receive and process the image data from the image capturing device 100 and the handwriting data from the signature capture device 101, and can be a microprocessor, digital signal processor, or other processor with computing capabilities. The storage unit 104 is coupled to the processing unit 102 and stores a program code 106, which instructs the processing unit 102 to execute a signature verification process 20 to determine the authenticity of the signature of the signatory through image capture and analysis.

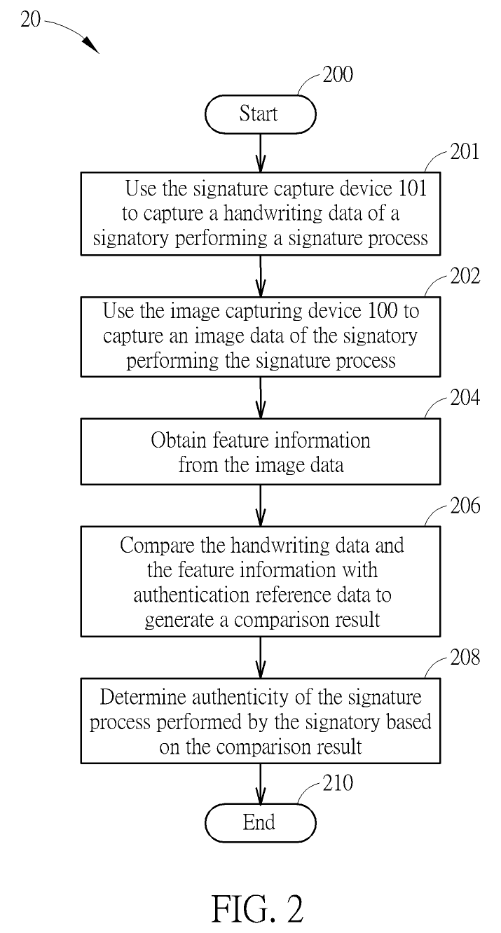

Specifically, please refer to FIG. 2, which is a schematic diagram of the signature verification process 20. The signature verification process 20 includes the following steps:

Step 200: Start.

Step 201: Use the signature capture device 101 to capture a handwriting data of a signatory performing a signature process.

Step 202: Use the image capturing device 100 to capture an image data of the signatory performing the signature process.

Step 204: Obtain feature information from the image data.

Step 206: Compare the handwriting data and the feature information with authentication reference data to generate a comparison result.

Step 208: Determine authenticity of the signature process performed by the signatory based on the comparison result.

Step 210: End.

According to the signature verification process 20, when the signatory signs, the signature verification system 10 captures the handwriting data during the signature process through the signature capture device 101 (Step 201). Simultaneously, the signature verification system 10 captures the image data of the signatory performing the signature process through the image capturing device 100 (Step 202), and analyzes the image data through the processing unit 102 to obtain the feature information (Step 204). Then, the signature verification system 10 compares the captured handwriting data and feature information with the pre-stored authentication reference data (Step 206) to determine the authenticity of the signature process performed by the signatory (Step 208). In short, the embodiment of the present invention verifies signature authenticity through image analysis and comparison of handwriting data and image data from the signature process. Since the signature process performed by the signatory includes various static and dynamic information reflecting personal characteristics such as writing habits and multi-dimensional hand features, which are extremely difficult to completely imitate, the embodiment of the present invention significantly improves signature verification accuracy and reliability compared to the conventional mechanisms that only verify the signatory's handwriting.

Specifically, in Step 201, the signature verification system 10 captures the handwriting data of the signatory through the signature capture device 101. The handwriting data can include, but is not limited to, two-dimensional spatial coordinates of handwriting, stylus pressure value changes during writing, tilt angle between pen tip and writing surface, and various time-varying trajectories. For example, in one embodiment, the signature capture device 101 can be implemented by using a capacitive touch pad or electromagnetic induction digital pad, which can detect information such as pressure, position, and tilt angle of the signatory's writing tool (stylus or finger) and convert the detected information into digital signals. In another embodiment, the signature capture device 101 can be configured with a high-resolution sensor array that can precisely record the trajectory of pen tip movement on the plane, including stroke start points, end points, and path points, to completely detect movement characteristics of the signature process. In another embodiment, the signature capture device 101 can have pressure sensing capability to record pressure changes of the pen tip on the writing surface during the signature process, reflecting the signatory's force variations between different strokes. In another embodiment, the signature capture device 101 can record timing information for each stroke, including writing speed, acceleration changes, and pause time between strokes, reflecting the signatory's writing habits and rhythm. In another embodiment, the signature capture device 101 can also capture the tilt angle between the pen tip and writing surface, reflecting the signatory's pen grip posture and writing habits, providing additional personal characteristics. The above information can be recorded in real-time during the signature process and converted to digital format stored as the handwriting data for subsequent feature comparison and verification.

In Step 202, the signature verification system 10 captures real-time image data of the signatory performing the signature process through the image capturing device 100. In this case, the image capturing device 100 is properly set up to ensure complete capture of important information such as the signatory's hand movements (relative positions of fingers and joints) and signature trajectories (relative movements of fingers and joints). The image data can be continuous dynamic image sequences or static images captured at specific time points, and not limited thereto. Moreover, although the signature verification system 10 in the embodiment of FIG. 1 only includes a single image capturing device 100, it is not limited to this; the signature verification system 10 can also include a plurality of image capturing devices. For example, in one embodiment, the signature verification system 10 is set up a plurality of image capturing devices and select one with the best shooting angle or range to generate the image data of the signature process; in another embodiment, the signature verification system 10 can integrate views from multiple image capturing devices to generate the image data of the signature process; in yet another embodiment, two or more image capturing devices can be integrated into one device with fixed relative positions. These techniques of using multiple image capturing devices to generate required image data should be familiar to those skilled in the art, so detailed operation methods will not be elaborated here.

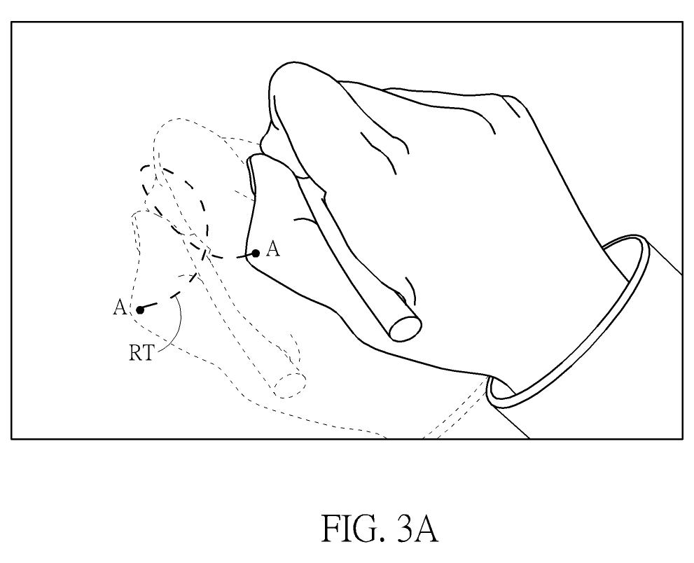

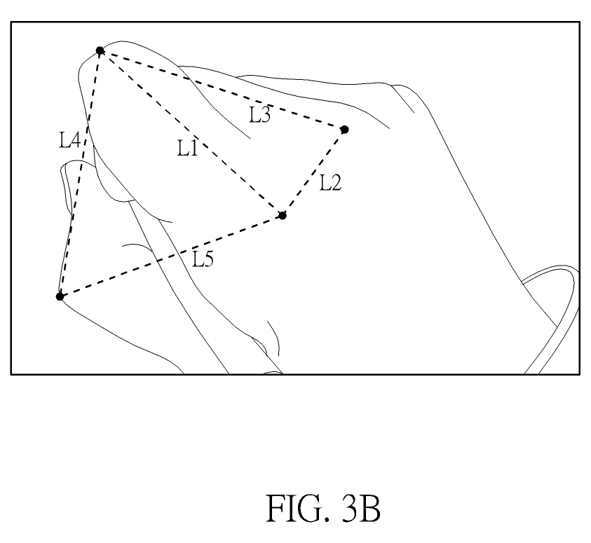

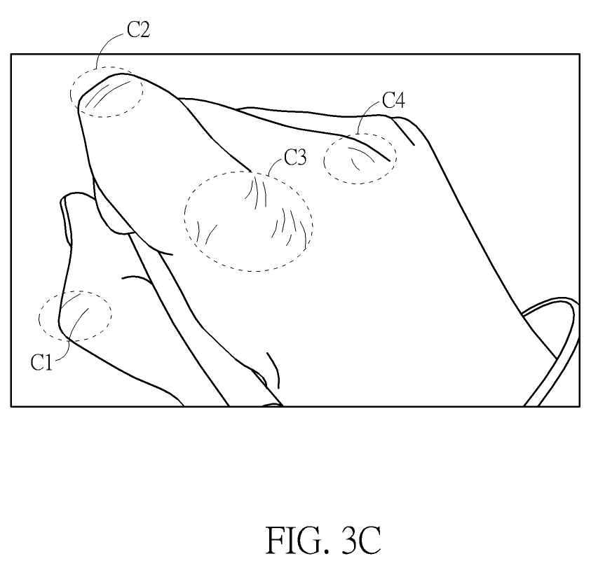

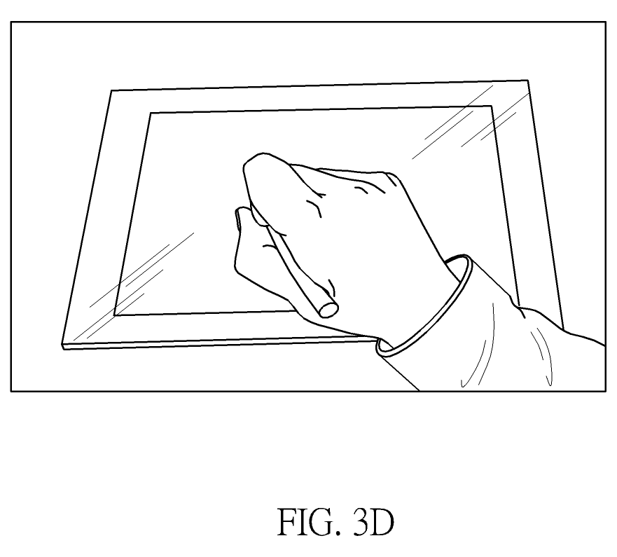

In Step 204, the processing unit 102 analyzes the image data of the signature process to obtain the feature information. In one embodiment, the feature information can be the dynamic trajectory of the signatory performing the signature process, such as the distance, path, speed, and acceleration of hand pattern or joint movements, or the distance, path, speed, and acceleration of movements between multiple joints. For example, please refer to FIG. 3A, which is a schematic diagram of a signature process image captured by the image capturing device 100. According to the signature process image shown in FIG. 3A, when the signatory performs the signature process, one joint A moves along a trajectory RT, so the trajectory RT can reflect the signatory's personalized characteristics during signing and can be served as feature information. The image capturing device 100 can also simultaneously detect movement trajectories of multiple joints and use the superimposed trajectories thereof as feature information. In other words, the processing unit 102 can analyze the signature process image captured by the image capturing device 100 in FIG. 3A, identify the trajectory RT therein as feature information for subsequent comparison.

In another embodiment, the feature information can be the relative positions of at least three joints in three-dimensional space when the signatory performs the signature process, which can reflect the characteristics of the signatory's signing posture, such as the relative positions between index finger metacarpophalangeal joint, index finger interphalangeal joint, middle finger metacarpophalangeal joint, middle finger interphalangeal joint, or thumb interphalangeal joint. For example, please refer to FIG. 3B, which is a schematic diagram of another signature process image captured by the image capturing device 100. According to the signature process image shown in FIG. 3B, when the signatory performs the signature process, multiple joints form a specific polygon that can be defined by distances L1-L5, reflecting personalized characteristics such as the signatory's pen grip method or posture during signing, and thus can be served as feature information. In other words, the processing unit 102 can analyze the signature process image captured by the image capturing device 100 in FIG. 3B, identify the distances L1-L5 therein as feature information for subsequent comparison.

In another embodiment, the feature information can be pattern features on finger of the signatory performing the signature process, such as pattern features on multiple joints, which can be served as additional identity verification criteria. For example, please refer to FIG. 3C, which is a schematic diagram of another signature process image captured by the image capturing device 100. According to the signature process image shown in FIG. 3C, when the signatory performs the signature process, multiple unique joint creases C1-C4 can be observed. Therefore, the joint creases C1-C4 and their relationships can reflect personalized characteristics such as the signatory's pen grip style or posture during signing, and thus can be served as feature information. In other words, the processing unit 102 can analyze the signature process image captured by the image capturing device 100 in FIG. 3C, identify the joints creases C1-C4 therein as feature information for subsequent comparison.

In another embodiment, the feature information can be static postures at specific time points during the signature process, such as hand postures at the beginning, during, and completion of signing, or the position of joints creases at specific time points, or the relative positions between at least three joints. For example, please refer to FIG. 3D, which is a schematic diagram of another signature process image captured by the image capturing device 100. The signature process image shown in FIG. 3D is a static posture at a specific time point during the signature process performed by the signatory, which can reflect personalized characteristics such as the signatory's pen grip style or posture during signing, and thus can be served as feature information. In other words, the processing unit 102 can analyze the signature process image captured by the image capturing device 100 in FIG. 3D, identify the static posture of the signatory during the signature process as feature information for subsequent comparison.

Moreover, it should be noted that the aforementioned signature process is not limited to whether the signatory uses a pen for signing. In some applications, the signatory might sign with one or more fingers, in which case the feature information should be appropriately adjusted according to different applications, which should be familiar to those skilled in the art. That is to say, regardless of the signing method adopted by the signatory, as long as the feature information reflecting the signatory's writing habits can be captured, it can be served as an important basis for determining signature authenticity, thereby significantly enhancing security.

In Step 206, the processing unit 102 compares the captured handwriting data and feature information with the pre-stored authentication reference data, and the authentication reference data can be obtained through various ways. For example, in one embodiment, the signatory needs to complete a registration procedure before performing the signature process, such as first capturing registration image data of the signatory performing a registration signature process through the image capturing device 100, obtaining registration feature information from the registration image data, and storing the registration feature information as the authentication reference data. The process of capturing the registration image data is not limited to execution through the image capturing device 100, and can also be completed through another image capturing device, such as electronic devices with image capture functionality like mobile phones or laptops. That is to say, the signatory previously performs the registration procedure using the image capturing device 100 or other electronic devices with image capture functionality, enabling the signature verification system 10 to obtain the authentication reference data from the registration image data for subsequent signature process comparison.

It should be noted that the purpose of the registration procedure is to generate the authentication reference data; however, whether to initiate the registration procedure or the execution timing and method thereof can be appropriately adjusted according to different requirements. For example, in one embodiment, when a signatory performs the signature process, if the signature verification system 10 discovers that authentication reference data for the signatory has not been established, the signature verification system 10 can automatically initiate the registration procedure to establish authentication reference data in real-time, allowing users to continue with the original signing operation after completing a one-time registration procedure. However, in application scenarios with higher security levels, the signature verification system 10 requires administrator review and authorization before executing the registration procedure. This authorization mechanism can include administrator identity verification, record keeping of the approval process, and full monitoring of the registration process. Additionally, the signature verification system 10 can also require the signatory to provide additional identity documents during registration or complete multiple registration signature processes within a specific time period based on the application scenario, to establish more complete and reliable authentication reference data.

Besides completing the registration procedure by capturing the registration image data through the image capturing device 100 or another image capturing device, in another embodiment, the authentication reference data might be pre-stored in a database (local or cloud database), and the signature verification system 10 can obtain the authentication reference data stored in the database through data transmission when comparison is needed (i.e., Step 206). Furthermore, to ensure data security, data needed for signature verification by the signature verification system 10 (such as image data, feature information, authentication reference data, registration image data, registration feature information, etc.) can undergo encryption process treatment during transmission and storage, for example, using blockchain technology for encryption. Correspondingly, if data undergoes encryption process treatment, decryption processing is needed when accessing or using it; for example, if the authentication reference data undergoes encryption process treatment, then the operation of decrypting the authentication reference data is included when comparing the feature information with the authentication reference data in Step 206.

On the other hand, since the feature information reflects the signatory's hand characteristics during signing, which can be dynamic trajectories during signing, finger angles, pattern features, static postures, etc., appropriate features can be selected as comparison criteria in Step 206. Furthermore, in one embodiment, the signature verification system 10 can assign different weights to various features based on parameters such as image quality and shooting angle. In another embodiment, the signature verification system 10 can introduce artificial intelligence technology to learn the correlation between multiple signature processes performed by the signatory in different postures to adjust the authentication reference data, thereby improving comparison accuracy and adaptability. For example, artificial intelligence technology can learn the correlation between various signature processes in which the signatory signs with standing, sitting, bending, using a pen, using index finger, and other postures, summarize the characteristics of the signatory's signing, and generate or adjust the authentication reference data accordingly to improve comparison accuracy when the signatory signs in different postures.

From the above embodiments, feature information obtained from the image data can be dynamic feature information during the signature process or static feature information at a specific time point during the signature process. Additionally, in one embodiment, the signature verification system 10 can also integrate the handwriting data and the feature information based on a timeline to form a composite information, and then compare the composite information with the authentication reference data to generate the comparison result. In other words, the signature verification system 10 can chronologically integrate various types of data during the signature process. During this integration process, the signature verification system 10 pairs and combines the handwriting data obtained from the signature capture device 101 with the feature information obtained from the image capturing device 100 according to their time of occurrence, so as to form the time-correlated composite information. For example, the signature verification system 10 can pair the handwriting data such as stroke coordinates, pressure values, and writing speed at a certain time point during the signature process with the feature information such as finger angles and relative position of joints captured at the same moment. The pairing process can continue throughout the entire signature process, from the start to the end of signing, forming a complete time-series feature sequence. As a result, the signature verification system 10 can capture dynamic behavioral characteristics of the signatory during the signature process, such as analyzing finger posture changes of the signatory during specific stroke writing, or the correlation between stylus pressure values and hand position changes at turning points. These time-correlated features can be used as personal identifiability thus increasing judgment accuracy.

After forming the composite information, the signature verification system 10 compares the composite information with the feature information. Since the composite information contains time-series feature sequences, the comparison process (step 206) considers not only the numerical similarity of various features but also the consistency of their temporal changes, such that derived variations can be familiar to those skilled in the art.

From the perspective of the image capturing device 100, the signatory's handwriting is inevitably obstructed by hand movements during the signature process which depends on pen grip posture, writing angle, and personal writing habits. In this case, the signature verification system 10 can use the signature capture device 101 as the primary source for capturing handwriting data, ensuring complete recording of stroke trajectories during the signature process. Meanwhile, although the image capturing device 100 is unable to fully capture all strokes due to hand occlusion, this partial occlusion phenomenon can also be viewed as a unique characteristic of the signatory. Different pen grip habits and writing postures will present different occlusion conditions in the image. The occlusion condition together with the visible parts of the handwriting can constitute personalized signature characteristics. When the image capturing device 100 and the signature capture device 101 are fixed, the personalized signature characteristics can have high consistency and reproductivity.

Moreover, the partial handwriting captured by the image capturing device 100 still can be cross-referenced with the complete handwriting recorded by the signature capture device 101, meaning that the feature information can include image-captured handwriting that matches the handwriting data. This multiple verification mechanism not only improves signature verification accuracy but also provides additional security protection for forgery detection. The signatory's microscopic behavioral characteristics during the signature process, such as changes in pen grip angle, relative positions of finger joints, and dynamic changes in handwriting occlusion, can all be precisely recorded and analyzed through this dual capture method.

In Step 208, the signature verification system 10 determines the authenticity of the signature process based on the comparison result of the handwriting data and/or the feature information with the authentication reference data. Furthermore, when the comparison result indicates that the signature is not authentic, the signature verification system 10 can take multiple measures, such as generating warning signals like visual prompts, audio prompts, or haptic feedback signals, or sending notification messages to designated recipients or administrators to report abnormal situations in real-time or trigger other preset security mechanisms. Additionally, the signature verification system 10 can also dynamically adjust threshold values for determination based on different application scenarios to balance security and usage convenience requirements.

In short, through the signature verification process 20, the embodiment of the present invention can not only capture static features of signature results (such as handwriting) but also capture dynamic information throughout the entire signature process, such as signature speed and pressure, habitual pauses during writing, stroke order when finishing, or other personalized characteristics. These habitual actions are often developed over long periods and unconscious, making them extremely difficult for others to completely imitate. Besides writing habits, the embodiment of the present invention can also capture multidimensional features such as the signatory's hand movements, signature trajectories, and finger angles. The combination of these dynamic features further increases the difficulty of forging signatures, significantly improving verification accuracy and reliability. Furthermore, the embodiment of the present invention can form the composite information by integrating handwriting data and feature information based on a timeline, thus providing more comprehensive capture of the signatory's signature characteristics, including not only static handwriting shapes but also dynamic behavioral features, thereby improving signature verification reliability and security. The embodiment of the present invention can also perform encryption and decryption processing on data that needs to be accessed or used for signature verification to ensure data security. Additionally, the embodiment of the present invention can integrate artificial intelligence technology through machine learning algorithms, enabling the signature verification system 10 to learn and identify signature characteristics of the same person under different circumstances, such as using different writing tools or signing in different postures, thereby improving verification accuracy and adaptability. Meanwhile, the signature verification system 10 of the embodiment of the present invention can be implemented on various devices with image capture functionality or electronic devices that can connect to external image capturing devices, including but not limited to personal computers, laptops, or mobile devices.

Therefore, the signature verification process 20 of the embodiment of the present invention can ensure signature verification reliability and security through multiple feature analysis, flexible data sources, encryption protection mechanisms, artificial intelligence assistance, and comprehensive warning systems, effectively preventing signature forgery while providing sufficient flexibility and scalability for practical applications.

Furthermore, the signature verification process 20 represents the main operational method of the signature verification system 10. When implementing the signature verification system 10, those skilled in the art should select appropriate components to correctly execute each step or derivative variation of the signature verification process 20. Specifically, the processing unit 102 can be a Microprocessor, Digital Signal Processor (DSP), or Microcontroller, while the storage unit 104 can be implemented by Read-Only Memory (ROM), Random Access Memory (RAM), Flash Memory, or other types of memory devices. The program code 106 is stored in the storage unit 104, and after system startup, the processing unit 102 can read and execute the program code 106 to implement various functions of the signature verification process 20. In another embodiment, computationally intensive or time-critical functions can be implemented using hardware circuits, while more complex logical decisions can be handled through software programs. This hybrid implementation approach achieves a balance between performance and flexibility and ensures system to have real-time capability and good scalability. Regardless of the implementation method, the processing unit 102correctly acquires signals or data captured by the image capturing device 100, which can be achieved through standard communication protocols such as Serial Communication Interface (SCI), Serial Peripheral Interface (SPI), or Inter-Integrated Circuit (I2C).

On the other hand, the signature verification system 10 utilizes the image capturing device 100 to capture the image data of the signatory performing the signature process for image analysis and comparison to verify signature authenticity. Therefore, the selection and setup of the image capturing device 100, including placement position, angle, sensitivity, focal length, resolution, and other parameter settings, prioritizes clearly capturing the signatory's hand movements and signature process. Additionally, to ensure the signatory signs in the appropriate position, specific signing locations can be planned according to the capturing characteristics of the image capturing device 100, or integrated with the signature capture device 101, allowing the signatory to perform the signature process in the appropriate position. Furthermore, the signature verification system 10 can incorporate prompt mechanisms, such as emitting sound or flashing lights when the signatory is not signing in the appropriate position, to guide the signatory in adjusting their signing position.

The signature capture device 101 is responsible for capturing handwriting trajectory data when the signatory performs the signature, which can be achieved through high-precision pressure sensing technology, touch screens, or other sensing components to achieve real-time, accurate capture of features such as stroke changes, writing speed, and pressure differences during the signature process, converting them into digitized handwriting data for subsequent verification analysis. Therefore, the selection of the signature capture device 101 should consider its sensitivity, resolution, and response speed to writing actions to ensure accurate capture of all writing details from the signatory. Additionally, the signature capture device 101 can be designed with ergonomic features for easy operation by the signatory and can be equipped with haptic feedback systems or display interfaces to assist the signatory in confirming whether their signature actions meet requirements.

The signature verification system 10 or the signature verification process 20 aims to verify signature authenticity, and those skilled in the art should be able to appropriately apply or implement it in various scenarios requiring identity verification. For example, in office environments, the signature verification system 10 or the signature verification process 20 can be applied to electronic document signing systems to ensure identity authenticity of the document signatory and can be integrated into enterprise security mechanisms as an identity verification method for employee workstation login or confidential data access. In the financial sector, the signature verification system 10 or the signature verification process 20 can be applied to bank counter service identity verification to enhance transaction security and can be integrated into mobile banking applications to replace traditional password verification, providing users with a more secure and convenient login method. In the retail sector, the signature verification system 10 or the signature verification process 20 can be applied to electronic payment system identity verification, particularly for large transaction authorization confirmation, and can be used in membership card systems to allow members to quickly complete identity verification through personalized signatures. In healthcare, the signature verification system 10 or the signature verification process 20 can be used for electronic signing of medical records and prescriptions to ensure medical document authenticity and integrity and applied to medical staff attendance signing or operating room access management. In education, the signature verification system 10 or the signature verification process 20 can be applied to identity verification in distance learning platforms to ensure student identity in online examinations and can be used in library borrowing systems or laboratory equipment usage management. In property management, the signature verification system 10 or the signature verification process 20 can be applied to resident building access identity verification, providing higher security than traditional access cards, and can be used for various public facility usage registration. In logistics, the signature verification system 10 or the signature verification process 20 can be applied to package receipt confirmation, not only recording recipient signatures but also verifying receiver identity in real-time. In public sector services, the signature verification system 10 or the signature verification process 20 can be applied to electronic signing of various government documents, improving administrative efficiency while ensuring document legal validity. These diverse application scenarios demonstrate how the present invention can provide safer, more convenient solutions for identity verification needs across various industries.

In conclusion, the signature verification system or the signature verification process of the present invention captures dynamic features during the signature process through the image capturing device in real-time, including not only static information needed for traditional signature comparison but also recording the signatory's unique writing habits and movement characteristics. In the analysis and comparison of feature information, the present invention integrates multiple verification mechanisms, including dynamic trajectory analysis, finger angle recognition, and biometric comparison, and can continuously learn and optimize judgment criteria through artificial intelligence technology. Furthermore, the present invention also provides comprehensive protection measures for data security, including data encryption storage and abnormal alert mechanisms, ensuring the reliability of the entire verification process. Therefore, the signature verification system or the signature verification process of the present invention can not only effectively prevent signature forgery but also adapt to various practical application scenarios, providing a practical and secure solution for identity verification in the digital age.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signature verification method based on image analysis, comprising:
capturing a handwriting data of a signatory performing a signature process by a signature capture device;
capturing an image data of the signatory performing the signature process by an image capturing device;
obtaining feature information from the image data;
comparing the handwriting data and the feature information with authentication reference data to generate a comparison result; and
determining authenticity of the signature process based on the comparison result.

2. The signature verification method of claim 1, wherein the feature information includes:
an angle of finger of the signatory performing the signature process.

3. The signature verification method of claim 1, wherein the feature information includes:
pattern feature on finger of the signatory performing the signature process.

4. The signature verification method of claim 1, wherein the feature information includes:
relative position of at least three finger joints of the signatory performing the signature process.

5. The signature verification method of claim 1, wherein the feature information is a dynamic feature information during the signature process.

6. The signature verification method of claim 1, wherein the feature information is a static feature information at a specific time point during the signature process.

7. The signature verification method of claim 1, further comprising:
integrating the handwriting data and the feature information based on a timeline to form a composite information, and comparing the composite information with the authentication reference data to generate the comparison result.

8. The signature verification method of claim 1, wherein the feature information includes:
a partially occluded handwriting obtained by comparing the image data with the handwriting data.

9. A signature verification system based on image analysis, comprising:
a signature capture device, configured to capture handwriting;
an image capturing device, configured to capture images;
a processing unit, coupled to the signature capture device and the image capturing device; and
a storage unit, coupled to the processing unit and storing a program code, wherein the program code instructs the processing unit to execute a signature verification method, and the signature verification method includes:
using the signature capture device to capture a handwriting data of a signatory performing a signature process;
using the image capturing device to capture an image data of the signatory performing the signature process;
obtaining feature information from the image data;
comparing the handwriting data and the feature information with authentication reference data to generate a comparison result; and
determining authenticity of the signature process based on the comparison result.

10. The signature verification system of claim 9, wherein the feature information includes:
an angle of finger of the signatory performing the signature process.

11. The signature verification system of claim 9, wherein the feature information includes:
pattern feature on finger of the signatory performing the signature process.

12. The signature verification system of claim 9, wherein the feature information includes:
relative position of at least three finger joints of the signatory performing the signature process.

13. The signature verification system of claim 9, wherein the feature information is a dynamic feature information during the signature process.

14. The signature verification system of claim 9, wherein the feature information is a static feature information at a specific time point during the signature process.

15. The signature verification system of claim 9, wherein the signature verification method further comprises:
integrating the handwriting data and the feature information based on a timeline to form a composite information, and comparing the composite information with the authentication reference data to generate the comparison result.

16. The signature verification system of claim 9, wherein the feature information includes:
a partially occluded handwriting obtained by comparing the image data with the handwriting data.

17. The signature verification system of claim 9, wherein the image capturing device has a plurality of image capturing units, and the image data of the signature process is obtained by integrating views captured from the plurality of image capturing units.

18. The signature verification system of claim 9, wherein a relative position between the image capturing device and the signature capture device is fixed.
